(19) United States
(12) Patent Application Publication
(10) Pub. No.: US 2025/0306282 A1
(43) Pub. Date: Oct. 2, 2025

(54) ULTRALOW LOSS INTERLAYER TRANSITION DESIGN FOR INTEGRATED MULTILAYER PHOTONIC PLATFORM

(71) Applicant: Lumentum Operations LLC, San Jose, CA (US)

(72) Inventors: Kangmei LI, San Jose, CA (US); Erman TIMURDOGAN, Arlington, MA (US)

(21) Appl. No.: 18/733,614

(22) Filed: Jun. 4, 2024

Related U.S. Application Data
(60) Provisional application No. 63/570,510, filed on Mar. 27, 2024.

(51) Int. Cl. G02B 6/26

(52) U.S. Cl. CPC G02B 6/268; G02B 6/262

(57) ABSTRACT

An interlayer transition coupling structure includes a first waveguide layer arranged in a cladding layer and configured to guide a first optical signal lengthwise along at least a first portion of the interlayer transition coupling structure; and a second waveguide layer arranged in the cladding layer and configured to guide a second optical signal lengthwise along at least a second portion of the interlayer transition coupling structure. The first waveguide layer and the second waveguide layer are spatially overlapped in a vertical direction in a third portion of the interlayer transition coupling structure. The first waveguide layer includes a displacing waveguide section that deviates from a tip section of the displacing waveguide section to avoid an abrupt layer-to-layer transition between the first waveguide layer and the second waveguide layer. An area of overlap between the displacing waveguide section and the second waveguide layer gradually changes.

### CROSS-REFERENCE TO RELATED APPLICATION

This Patent application claims priority to U.S. Provisional Patent Application No. 63/570,510, filed on Mar. 27, 2024, and entitled “ULTRALOW LOSS INTERLAYER TRANSITION DESIGN FOR INTEGRATED MULTILAYER PHOTONIC PLATFORM.” The disclosure of the prior Application is considered part of and is incorporated by reference into this Patent Application.

### TECHNICAL FIELD

The present disclosure relates generally to interlayer transition coupling structures in an optical system.

### BACKGROUND

Silicon photonics is a cost-effective and scalable platform for integrating many types of devices, such as optical waveguides, multi-mode interferometers (MMIs), optical couplers, optical modulators, and photodiodes on a same silicon photonic chip to enable low-cost transceivers. One key component is a spot size converter (SSC), which enables coupling of light between a silicon photonic chip and an optical fiber. A typical silicon (Si) waveguide (WG) used in functional devices has a mode field diameter (MFD) in the order of 0.1 μm, while the MFD of a standard single-mode fiber (SMF) is around 10 μm. The relatively large MFD of the SMF requires (1) an SSC to expand the mode as it transitions into low-index, silicon dioxide (SiO₂) cladding from a high-index Si-On-Insulator (SOI) waveguide, and (2) an Si substrate to be far enough from the SOI waveguide to avoid loss to the Si substrate.

A large physical separation between the Si substrate and the Si waveguide leads to an increased thermal isolation due to SiO₂ being a poor thermal conductor. The increased thermal isolation introduces challenges if the Si waveguide heats up due to linear (propagation) and nonlinear (two-photon and free carrier absorptions) losses. Modern transceivers with optical input powers greater than 20 decibel-milliwatts (dBm) can damage or increase the losses of Si SSC couplers. An alternative solution is to use other materials such as a silicon-nitride-based material (e.g., SiₓN_{y}, where x and y are placeholders for a chemical formula of silicon nitride) for the SSC. SiₓN_{y} can handle much higher power than Si due to SiₓN_{y} having low linear and negligible nonlinear absorption. However, SiₓN_{y} is not a conductor and Si may be necessary for building active devices on a same platform. In such a platform, an interlayer transition coupling structure between Si and SiₓN_{y} waveguide layers is required to couple light from an SiₓN_{y} waveguide layer to an Si waveguide layer. If a platform is chosen to have more than a single layer of SiₓN_{y}, interlayer transitions between multiple SiₓN_{y} waveguide layers can be also needed.

### SUMMARY

In some implementations, an interlayer transition coupling structure includes a first lateral interface and a second lateral interface that are perpendicular to a first lateral axis and define a lengthwise dimension of the interlayer transition coupling structure; a first lateral side and a second lateral side that are perpendicular to a second lateral axis and define a widthwise dimension of the interlayer transition coupling structure; a cladding layer; a first waveguide layer arranged in the cladding layer and configured to guide a first optical signal lengthwise along at least a first portion of the interlayer transition coupling structure; and a second waveguide layer arranged in the cladding layer and configured to guide a second optical signal lengthwise along at least a second portion of the interlayer transition coupling structure, wherein the first waveguide layer and the second waveguide layer are spatially overlapped in a vertical direction in a third portion of the interlayer transition coupling structure, wherein the first waveguide layer and the second waveguide layer are optically coupled in the vertical direction to transfer an optical signal between the first waveguide layer and the second waveguide layer, wherein the first waveguide layer includes: a first constant width section that extends lengthwise, along a first center axis, from the first lateral interface toward the second lateral interface, wherein the first constant width section has a first constant width; a first tapered width section that extends lengthwise, along the first center axis, from the first constant width section toward the second lateral interface, wherein the first tapered width section has a first tapered width that tapers from the first constant width section to a first tip section having a first tip width; and a first displacing waveguide section that extends from the first tip section to the second lateral interface, wherein the first displacing waveguide section has a first displaced waveguide tip, arranged at the second lateral interface, that has a first lateral offset distance from the first center axis, wherein the second waveguide layer includes: a second constant width section that extends lengthwise, along a second center axis, from the second lateral interface toward the first lateral interface, wherein the second constant width section has a second constant width; and a second tapered width section that extends lengthwise, along the second center axis, from the second constant width section toward the first lateral interface, wherein the second tapered width section has a second tapered width that tapers from the second constant width section to a second tip section having a second tip width.

In some implementations, a multicore waveguide includes a first lateral interface and a second lateral interface that are perpendicular to a first lateral axis and define a lengthwise dimension of the multicore waveguide; a first lateral side and a second lateral side that are perpendicular to a second lateral axis and define a widthwise dimension of the multicore waveguide; a cladding layer; a first waveguide core arranged in the cladding layer and configured to guide a first optical signal lengthwise along at least a first portion of the multicore waveguide; and a second waveguide core arranged in the cladding layer and configured to guide a second optical signal lengthwise along at least a second portion of the multicore waveguide, wherein the first waveguide core and the second waveguide core are spatially overlapped in a vertical direction in a third portion of the interlayer transition coupling structure, wherein the first waveguide core and the second waveguide core are optically coupled in the vertical direction to transfer an optical signal between the first waveguide core and the second waveguide core, wherein the first waveguide core includes: a first constant width section that extends lengthwise, along a first center axis, from the first lateral interface toward the second lateral interface, wherein the first constant width section has a first constant width; a first tapered width section that extends lengthwise, along the first center axis, from the first constant width section toward the second lateral interface, wherein the first tapered width section has a first tapered width that tapers from the first constant width section to a first tip section having a first tip width; and a first displacing waveguide section that extends from the first tip section to the second lateral interface, wherein the first displacing waveguide section has a first displaced waveguide tip, arranged at the second lateral interface, that has a first lateral offset distance from the first center axis, wherein the second waveguide core includes: a second constant width section that extends lengthwise, along a second center axis, from the second lateral interface toward the first lateral interface, wherein the second constant width section has a second constant width; and a second tapered width section that extends lengthwise, along the second center axis, from the second constant width section toward the first lateral interface, wherein the second tapered width section has a second tapered width that tapers from the second constant width section to a second tip section having a second tip width.

In some implementations, an interlayer transition coupling structure includes a first waveguide mode path configured to propagate a first waveguide mode; and a second waveguide mode path configured to propagate a second waveguide mode, wherein the first waveguide mode path and the second waveguide mode path are partially overlapped and are configured to couple the first waveguide mode and second waveguide mode, wherein the first waveguide mode path has a waveguide tip section, wherein the first waveguide mode path has a displacement mode path starting at the waveguide tip section, wherein the displacement mode path is gradually displaced from the second waveguide mode path, and wherein the displacement mode path is configured to gradually decouple the first waveguide mode from the second waveguide mode or gradually couple the first waveguide mode to the second waveguide mode.

### BRIEF DESCRIPTION OF THE DRAWINGS

FIG. 1A shows a top view of an interlayer transition coupling structure according to one or more implementations.

FIG. 1B shows a side view of the interlayer transition coupling structure shown in FIG. 1A.

FIG. 2 shows a top view of an interlayer transition coupling structure according to one or more implementations.

FIG. 3 shows a top view of an interlayer transition coupling structure according to one or more implementations.

### DETAILED DESCRIPTION

The following detailed description of example implementations refers to the accompanying drawings. The same reference numbers in different drawings may identify the same or similar elements.

Interlayer transition designs may include an Si waveguide and an SiₓN_{y} waveguide that are both tapered at respective coupling ends to enable optical coupling. While this design allows for a low loss adiabatic transition by evolving the mode from SiₓN_{y} to Si or vice versa, a tapered section must end at a physical tip with a physical tip width (e.g., ˜100-300 nm) that is nonzero due to limitations of minimum mask resolution and lithographic etch recipes. This design leads to two interfaces (e.g., coupling interfaces) where there is an abrupt change from a dual layer waveguide, where Si and SiₓN_{y} waveguide overlap, to isolated waveguides (e.g., single layer waveguide of Si or SiₓN_{y}) where there is no Si and SiₓN_{y} waveguide overlap. Mitigating the mode mismatch losses is limited by how much the widths of the Si and SiₓN_{y} waveguide tips can be reduced, and especially by the width of the Si waveguide tip.

The abrupt end of the Si waveguide tip not only introduces mode mismatch loss, but also leads to back reflection. Back reflection is especially critical for all optical systems that include lasers. The back reflection may increase relative intensity noise, linewidth, mode hops, and instability. For transceivers, back reflection may lead to multi-path interference (MPI), which may have a direct impact on sensitivity and bit-error-rate floor for such a system. A passive component, such as an interlayer transition, should have low reflection by design to avoid being a bottleneck in a transceiver reflection budget.

Some implementations provide an optical coupler (e.g., interlayer transition coupling structure) with an ultralow-loss interlayer transition for an integrated multilayer photonic platform. The optical coupler may be implemented in an SSC. The optical coupler may bypass mode mismatch to achieve an ultralow loss, low crosstalk, and low reflection interlayer transition. While the optical coupler described herein is based on a silicon layer and an SiₓN_{y} layer platform, the optical coupler may generally be applicable to interlayer transitions in other material platforms, as well as platforms with multiple Si and SiₓN_{y} layers. The interlayer transition may avoid abrupt layer-to-layer transitions to achieve ultralow loss and to reduce back reflections that typically occur due to abrupt layer-to-layer transitions (e.g., due to waveguide layer tips). The optical coupler may include a displacing waveguide segment of a same width as an Si waveguide tip to avoid an abrupt change at an interface. Thus, the optical coupler may have an improved interlayer coupling performance (e.g., lower loss, less crosstalk, and/or less back reflection).

In some implementations, an interlayer transition coupling structure includes a first waveguide layer arranged in a cladding layer and configured to guide a first optical signal lengthwise along at least a first portion of the interlayer transition coupling structure, and a second waveguide layer arranged in the cladding layer and configured to guide a second optical signal lengthwise along at least a second portion of the interlayer transition coupling structure. The first waveguide layer and the second waveguide layer are spatially overlapped in a vertical direction in a third portion of the interlayer transition coupling structure. The first waveguide layer includes a displacing waveguide section that deviates from a tip section of the displacing waveguide section to avoid an abrupt layer-to-layer transition between the first waveguide layer and the second waveguide layer. An area of overlap between the displacing waveguide section and the second waveguide layer gradually changes.

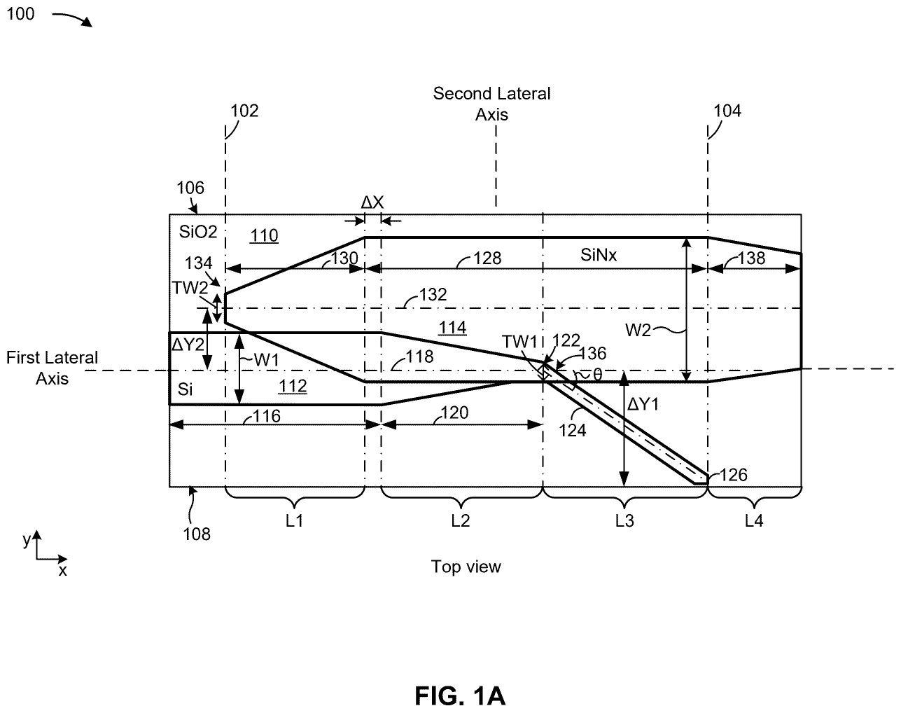

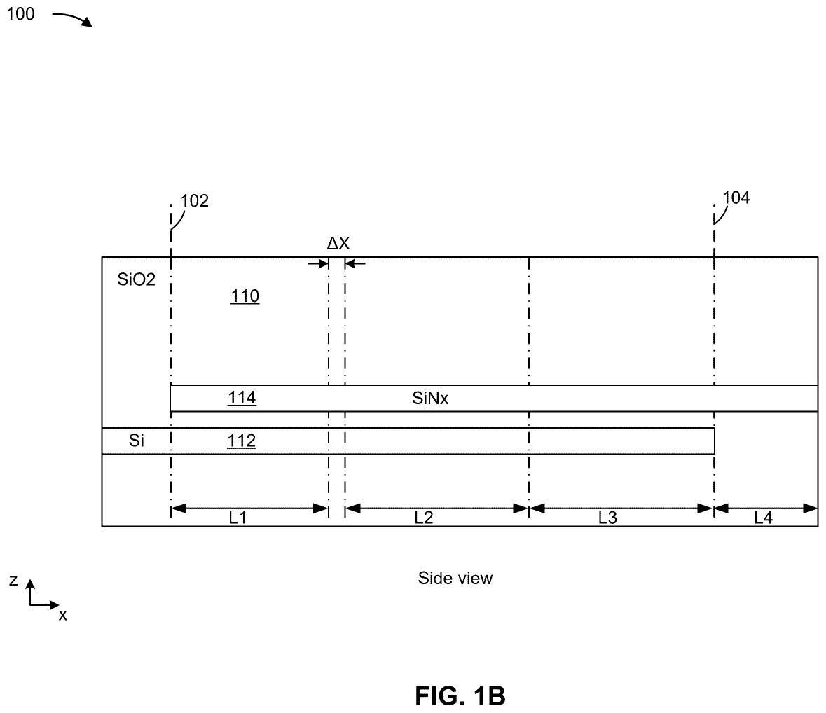

FIG. 1A shows a top view of an interlayer transition coupling structure 100 according to one or more implementations. FIG. 1B shows a side view of the interlayer transition coupling structure 100 according to one or more implementations. A lateral plane (e.g., an x/y plane) may be defined by an x-axis that may define a lengthwise dimension and a y-axis that may define a widthwise dimension. A z-axis may define a vertical direction or a corresponding thickness dimension.

The interlayer transition coupling structure 100 may include a first lateral interface 102 and a second lateral interface 104 that are perpendicular to a first lateral axis (e.g., the x-axis) and define a lengthwise dimension of the interlayer transition coupling structure 100. Additionally, the interlayer transition coupling structure 100 may include a first lateral side 106 and a second lateral side 108 that are perpendicular to a second lateral axis (e.g., the y-axis) and define a widthwise dimension of the interlayer transition coupling structure 100. The interlayer transition coupling structure 100 may include a cladding layer 110 (e.g., SiO₂), a first waveguide layer 112 (e.g., an Si layer) arranged in the cladding layer 110 and configured to guide a first optical signal lengthwise along at least a first portion of the interlayer transition coupling structure 100, and a second waveguide layer 114 (e.g., an SiₓN_{y} layer) arranged in the cladding layer 110 and configured to guide a second optical signal lengthwise along at least a second portion of the interlayer transition coupling structure 100. The first waveguide layer 112 and the second waveguide layer 114 may be made of different waveguide materials to enable edge coupling of light between a silicon photonic chip and an optical fiber with reduced mode mismatch losses and low back reflection.

In general, light may be received at the first lateral interface 102 and guided to the second lateral interface 104, or light may be received at the second lateral interface 104 and guided to the first lateral interface 102. The first waveguide layer 112 and the second waveguide layer 114 may be two-dimensional (2D) waveguides. The cladding layer 110 may be formed by one or more layers of cladding material, such as SiO₂. In some implementations, the interlayer transition coupling structure 100 may be a multicore waveguide, the first waveguide layer 112 may be a first waveguide core, and the second waveguide layer 114 may be a second waveguide core.

The first waveguide layer 112 and the second waveguide layer 114 are spatially overlapped, at least in part, in the vertical direction in a third portion of the interlayer transition coupling structure 100. The first waveguide layer 112 and the second waveguide layer 114 are optically coupled in the vertical direction to transfer an optical signal between the first waveguide layer 112 and the second waveguide layer 114. For example, first waveguide layer 112 may be a first waveguide mode path configured to propagate a first waveguide mode (e.g., the first optical signal travels through the first waveguide mode path in the first waveguide mode), and the second waveguide layer 114 may be a second waveguide mode path configured to propagate a second waveguide mode (e.g., the second optical signal travels through the second waveguide mode path in the second waveguide mode). The first waveguide mode path and the second waveguide mode path may be at least partially overlapped in such a way that the first waveguide mode path and the second waveguide mode path are configured to couple the first waveguide mode and second waveguide mode.

In some implementations, the first waveguide layer 112 and the second waveguide layer 114 may be spatially separated in the vertical direction by a portion of the cladding layer 110. Thus, the first waveguide layer 112 and the second waveguide layer 114 may be optically coupled in the vertical direction by an evanescent-wave coupling to transfer an optical power between the first waveguide layer 112 and the second waveguide layer 114. As a result, the first optical signal and the second optical signal are different optical signals (or waveguide modes) having substantially equal effective propagation indices.

In some implementations, the first waveguide layer 112 and the second waveguide layer 114 are part of a same waveguide layer having different thicknesses. In other words, there may be no vertical separation between the first waveguide layer 112 and the second waveguide layer 114. As a result, the first optical signal and the second optical signal may be a same optical signal (or waveguide mode) that is transferred directly (e.g., direct coupling) between the first waveguide layer 112 and the second waveguide layer 114.

The first waveguide layer 112 may include a first constant width section 116 (e.g., a that extends lengthwise, along a first center axis 118, at least from the first lateral interface 102 toward the second lateral interface 104. The first constant width section 116 has a first constant width W1. The first waveguide layer 112 may further include a first tapered width section 120 (e.g., a first waveguide tapered section) that extends lengthwise, along the first center axis 118, from the first constant width section 116 toward the second lateral interface 104. The tapering may be symmetrical or asymmetrical relative to the first center axis 118. The first tapered width section 120 has a first tapered width that tapers from the first constant width section 116 to a first tip section 122 having a first tip width TW1. The first waveguide layer 112 may further include a first displacing waveguide section 124 (e.g., a displacement mode path) that extends from the first tip section 122 to the second lateral interface 104. The first displacing waveguide section 124 may have a first displaced waveguide tip 126, arranged at the second lateral interface 104, that has a first lateral offset distance ΔY1 from the first center axis 118. The first displacing waveguide section 124 may extend toward (or to) the second lateral side 108.

Thus, the first waveguide layer 112 (e.g., the first waveguide mode path) may have a displacement mode path starting at the first tip section 122 (e.g., at an end of the first tapered width section 120) of the first tapered width section 120. The displacement mode path may be gradually displaced from the second waveguide layer 114 (e.g., the second waveguide mode path) by the first lateral offset distance ΔY1 such that the displacement mode path is configured to gradually decouple the first waveguide mode from the second waveguide mode or gradually couple the first waveguide mode to the second waveguide mode.

The first displacing waveguide section 124 may extend from the first tip section 122 to the second lateral interface 104 in both a first lateral direction (e.g., an x-direction) that is parallel to the first lateral axis (e.g., the x-axis) and a second lateral direction (e.g., a y-direction) that is parallel to the second lateral axis (e.g., the y-axis). For example, the first displacing waveguide section 124 may be a slanted waveguide that slants at an offset angle θ relative to the first center axis 118 and extends from the first tip section 122 at the offset angle θ toward the second lateral side 108. An excessively large offset angle θ will cause excessive loss, while an excessively small offset angle θ will make the interlayer transition coupling structure 100 unsuitably long without much improvement of the performance. Thus, the offset angle θ may be in a range between 0.5° to 20° to avoid excessively small offset angles θ and excessively large offset angles θ. The slanted waveguide may be a straight waveguide, with straight edges (e.g., no curves).

The second waveguide layer 114 may include a second constant width section 128 that extends lengthwise, along a second center axis, from the second lateral interface 104 toward the first lateral interface 102, wherein the second constant width section 128 has a second constant width W2. The second waveguide layer 114 may further include a second tapered width section 130 (e.g., a second waveguide tapered section) that extends lengthwise, along the second center axis 132, from the second constant width section 128 toward the first lateral interface 102. The tapering may be symmetrical or asymmetrical relative to the first center axis 132. The second tapered width section 130 may have a second tapered width that tapers from the second constant width section 128 to a second tip section 134 having a second tip width TW2. Thus, the first tapered width section 120 and the second tapered width section 130 taper in opposite directions.

The first constant width section 116 and the second tapered width section 130 may be spatially overlapped, at least in part, in the vertical direction. Moreover, the second constant width section 128 and the first tapered width section 120 may be spatially overlapped, at least in part, in the vertical direction.

In addition, a first lateral end portion of the first constant width section 116 may be spatially overlapped, at least in part, with a second lateral end portion of the second constant width section 128, where overlapping sections of the first lateral end portion and second lateral end portion are represented by lateral overlap ΔX. In some implementations, the lateral overlap ΔX may be zero, such that the first constant width section 116 and the second constant width section 128 do not spatially overlap in the vertical direction. However, when the lateral overlap ΔX is greater than zero, meaning there is some overlap between the first constant width section 116 and the second constant width section 128, the lateral overlap ΔX may allow higher tolerance to fabrication registration errors (e.g., lateral alignment errors) between the first waveguide layer 112 and the second waveguide layer 114.

The first displacing waveguide section 124 may include a coupling portion 136 that is spatially overlapped with the second constant width section 128 of the second waveguide layer 114. An area of overlap between the coupling portion 136 and the second constant width section 128 in the vertical direction may gradually decrease as the first displacing waveguide section 124 extends from the first tip section 122 toward the second lateral interface 104. In other words, the first displacing waveguide section 124 extends from the first tip section 122 to the second lateral interface 104 such that a spatial overlap between the first displacing waveguide section 124 and the second constant width section 128 gradually decreases. The first displaced waveguide tip 126 is arranged at the first lateral offset distance ΔY1 such that the displaced waveguide tip 126 and the second waveguide layer 114 are not spatially overlapped in the vertical direction. The first lateral offset distance ΔY1 may be sufficiently large such that one or more effective indices of one or more waveguide modes of the second waveguide layer 114 have a negligible change as the one or more waveguide modes cross a boundary between the first tip section 122 and the second lateral interface 104.

As a result, the first displacing waveguide section 124 may gradually transition away from the second waveguide layer 114, which avoids an abrupt transition or change between the first waveguide layer 112 and the second waveguide layer 114. In other words, the first waveguide layer 112 does not have an abrupt end that overlaps with the second waveguide layer 114, which may reduce mode mismatch loss and/or back reflection within the interlayer transition coupling structure 100. The first displacing waveguide section 124 may be configured to conduct an optical signal from a first region that is spatially overlapped with the second waveguide layer 114 to a second region that is not spatially overlapped with the second waveguide layer 114. Light (or optical power) may be gradually coupled out from the coupling portion 136 (and out from the first waveguide layer 112) and into the second constant width section 128. Alternatively, light (or optical power) may be gradually coupled out from the second constant width section 128 and into the coupling portion 136 (and into the first waveguide layer 112). Thus, coupling portion 136 is optically coupled to the second constant width section 128. In some implementations, the optical coupling may be an evanescent-wave coupling.

The first displacing waveguide section 124 may be configured to reduce at least one of: a mode mismatch loss of the optical signal, which is transferred between the first waveguide layer 112 and the second waveguide layer 114; a back reflection from the first waveguide layer 112 and the second waveguide layer 114 during transfer of the optical signal; or a crosstalk between the first waveguide layer 112 and the second waveguide layer 114 during transfer of the optical signal.

In some implementations, the first center axis 118 and the second center axis 132 are colinear. Thus, the second tip section 134 may be spatially overlapped with the first constant width section 116.

In some implementations, the first center axis 118 and the second center axis 132 may be laterally offset by a second lateral offset distance ΔY2 in a first direction (e.g., a positive y-direction) that is parallel to the second lateral axis (e.g., the y-axis). In some implementations, the second lateral offset distance ΔY2 is sufficiently large such that the second tip section 134 is not spatially overlapped with the first constant width section 116. The first lateral offset distance ΔY1 may extend from the first center axis 118 in a second direction (e.g., a negative y-direction) that is parallel to the second lateral axis, where the first direction and the second direction are opposite directions. The second lateral offset distance ΔY2 may be configured to be sufficiently large to reduce crosstalk and reduce transverse magnetic (TM) mode loss.

In some implementations, the second waveguide layer 114 has a third tapered section 138 that tapers lengthwise, along the second center axis 132, from the second constant width section 128 away from the first lateral interface 102 and away from the second lateral interface 104. The third tapered section 138 may taper from the second constant width W2 to a width that matches a width of an SiₓN_{y} routing waveguide (not illustrated) that is coupled to the interlayer transition coupling structure 100, to ensure low coupling loss.

The second tapered width section 130 may have a length L1, the first tapered width section 120 may have a length L2, a segment from the first tip section 122 to the first displaced waveguide tip 126 (e.g., at the second lateral interface 104) may have a length L3, and the third tapered section 138 may have a length L4. Lengths L1, L2, L3, L4 and widths W1, W2 may be configured to ensure an optical transition with low loss and low crosstalk. For example, the design parameters for the interlayer transition coupling structure 100 may be set accordingly: L1: 20 μm; L2: 75 μm; L3: 150 μm; L4: 25 μm; W1: 500 nm; W2: 1500 nm; ΔY1: 2.5 μm; ΔY2: 400 nm; ΔX: 2.5 μm; and 0:0.95°. As a result, there is significant reduction of TM mode loss in the interlayer transition coupling structure 100 compared to interlayer transition designs that do not include the first displacing waveguide section 124. For example, the TM mode loss with the above design parameters may be about 0.02 dB, when compared to 0.3 dB for an interlayer transition design that does not include the first displacing waveguide section 124. In addition, the interlayer transition coupling structure 100 with the above design parameters may reduce a TM-TE1 loss from −19 dB to −26 dB (maximum in the wavelength range of 1.5-1.6 μm), and may reduce back reflection from −29 dB to −39 dB (maximum in the wavelength range of 1.5-1.6 μm). Widths W1 and W2 may be dimensioned to avoid crosstalk and loss.

Alternatively, the design parameters for the interlayer transition coupling structure 100 may be set accordingly: L1: 20 μm; L2: 100 μm; L3: 13 0 μm; L4: 25 μm; W1: 500 nm; W2: 1800 nm; ΔY1: 1.5 μm; and ΔY2: 400 nm. As a result, TM mode loss may be reduced from around 0.45 dB to around 0.03 dB, TM-TE1 crosstalk may be reduced from around-18 dB to below-28 dB, and back reflection may be reduced from around-30 dB to below-38 dB. Thus, the design parameters for the interlayer transition coupling structure 100 are configurable to reduce loss, crosstalk, and/or back reflection, and may depend on the waveguide materials and the wavelength of light. Other values for the design parameters may be used and are not limited to the examples provided herein.

In some implementations, the second waveguide layer 114 may have a second displacing waveguide section (e.g., a second displacement mode path) that extends from the second tip section 134 toward the first lateral side 106, in a similar manner as described in relation to the first displacing waveguide section 124. Thus, the waveguide layer 114 may (e.g., the second waveguide mode path) may have a displacement mode path starting at the second tip section 134 of the second tapered width section 130. The second displacement mode path may be gradually displaced from the first waveguide layer 112 (e.g., the first waveguide mode path) such that the second displacement mode path is configured to gradually decouple the second waveguide mode from the first waveguide mode or gradually couple the second waveguide mode to the first waveguide mode.

As indicated above, FIGS. 1A and 1B are provided as examples. Other examples may differ from what is described with regard to FIGS. 1A and 1B.

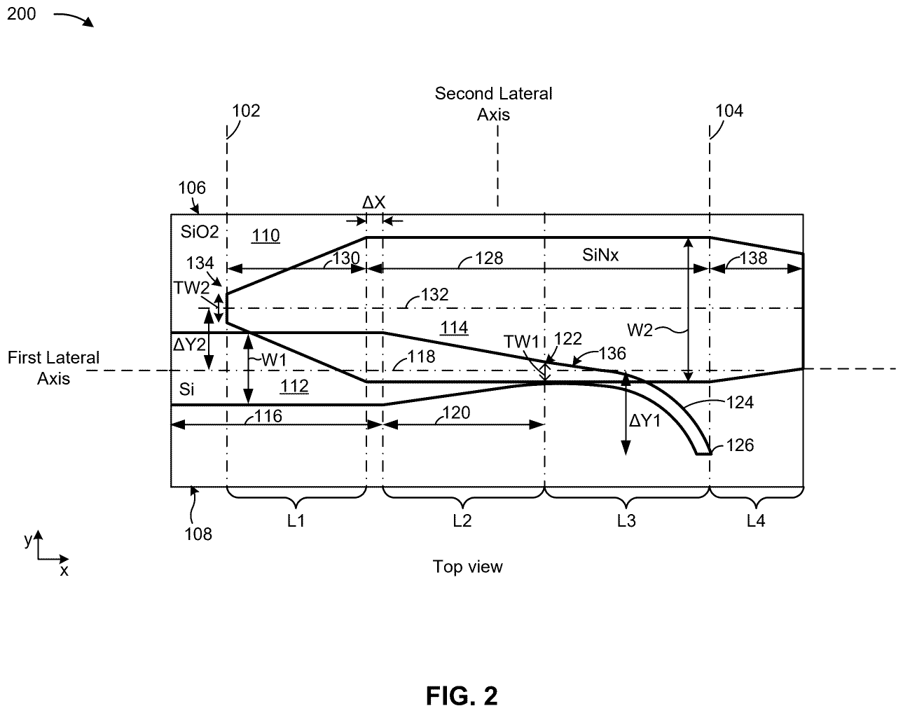

FIG. 2 shows a top view of an interlayer transition coupling structure 200 according to one or more implementations. The interlayer transition coupling structure 200 is similar to the interlayer transition coupling structure 100 described in connection with FIGS. 1A and 1B, with an exception that the first displacing waveguide section 124 is a curved waveguide having one or more curves. The first displacing waveguide section 124 extends in a first lateral direction that is parallel to the first lateral axis (e.g., the x-axis) and in a second lateral direction that is parallel to the second lateral axis (e.g., the y-axis). The first displaced waveguide tip 126 of the first displacing waveguide section 124 may extend to the second lateral interface 104 and may have a first lateral offset distance ΔY1 from the first center axis 118.

An area of overlap between the coupling portion 136 and the second constant width section 128 in the vertical direction may gradually decrease as the first displacing waveguide section 124 extends from the first tip section 122 toward the second lateral interface 104. The first lateral offset distance ΔY1 may be sufficiently large such that one or more effective indices of one or more waveguide modes of the second waveguide layer 114 have a negligible change as the one or more waveguide modes cross a boundary between the first tip section 122 and the second lateral interface 104.

As a result, the first displacing waveguide section 124 may gradually transition away from the second waveguide layer 114, which avoids an abrupt transition or change between the first waveguide layer 112 and the second waveguide layer 114. In other words, the first waveguide layer 112 does not have an abrupt end that overlaps with the second waveguide layer 114, which may reduce mode mismatch loss and/or back reflection within the interlayer transition coupling structure 100. The first displacing waveguide section 124 may be configured to conduct an optical signal from a first region that is spatially overlapped with the second waveguide layer 114 to a second region that is not spatially overlapped with the second waveguide layer 114. Light (or optical power) may be gradually coupled out from the coupling portion 136 (and out from the first waveguide layer 112) and into the second constant width section 128. Alternatively, light (or optical power) may be gradually coupled out from the second constant width section 128 and into the coupling portion 136 (and into the first waveguide layer 112). Thus, coupling portion 136 is optically coupled to the second constant width section 128. In some implementations, the optical coupling may be an evanescent-wave coupling.

As indicated above, FIG. 2 is provided as an example. Other examples may differ from what is described with regard to FIG. 2.

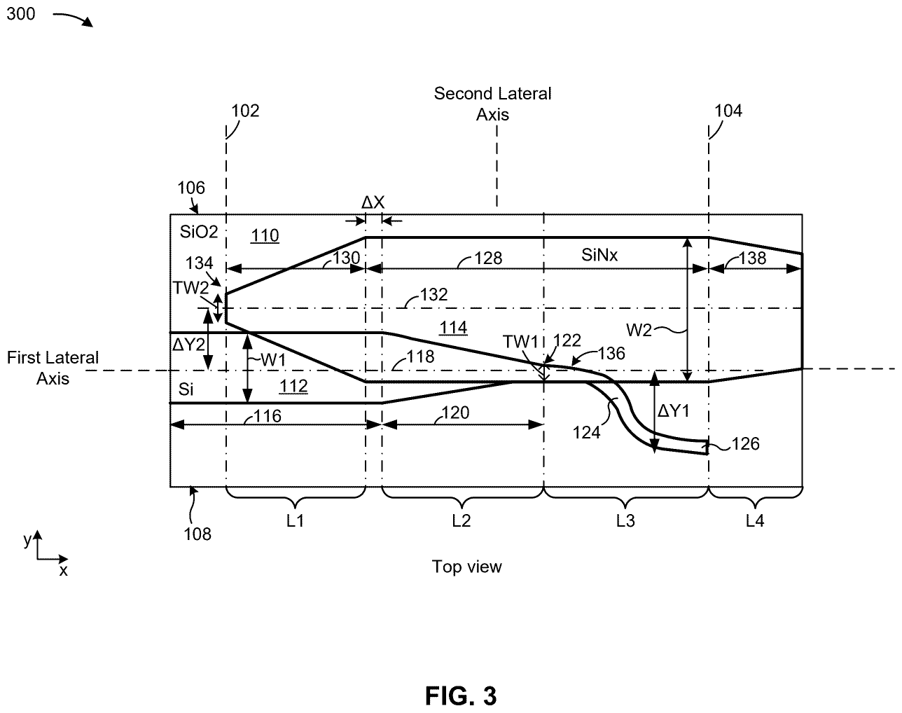

FIG. 3 shows a top view of an interlayer transition coupling structure 300 according to one or more implementations. The interlayer transition coupling structure 300 is similar to the interlayer transition coupling structure 100 described in connection with FIGS. 1A and 1B, with an exception that the first displacing waveguide section 124 is a curved waveguide having one or more curves. The first displacing waveguide section 124 extends in a first lateral direction that is parallel to the first lateral axis (e.g., the x-axis) and in a second lateral direction that is parallel to the second lateral axis (e.g., the y-axis). The first displaced waveguide tip 126 of the first displacing waveguide section 124 may extend to the second lateral interface 104 and may have a first lateral offset distance ΔY1 from the first center axis 118.

An area of overlap between the coupling portion 136 and the second constant width section 128 in the vertical direction may gradually decrease as the first displacing waveguide section 124 extends from the first tip section 122 toward the second lateral interface 104. The first lateral offset distance ΔY1 may be sufficiently large such that one or more effective indices of one or more waveguide modes of the second waveguide layer 114 have a negligible change as the one or more waveguide modes cross a boundary between the first tip section 122 and the second lateral interface 104.

As a result, the first displacing waveguide section 124 may gradually transition away from the second waveguide layer 114, which avoids an abrupt transition or change between the first waveguide layer 112 and the second waveguide layer 114. In other words, the first waveguide layer 112 does not have an abrupt end that overlaps with the second waveguide layer 114, which may reduce mode mismatch loss and/or back reflection within the interlayer transition coupling structure 100. The first displacing waveguide section 124 may be configured to conduct an optical signal from a first region that is spatially overlapped with the second waveguide layer 114 to a second region that is not spatially overlapped with the second waveguide layer 114. Light (or optical power) may be gradually coupled out from the coupling portion 136 (and out from the first waveguide layer 112) and into the second constant width section 128. Alternatively, light (or optical power) may be gradually coupled out from the second constant width section 128 and into the coupling portion 136 (and into the first waveguide layer 112). Thus, coupling portion 136 is optically coupled to the second constant width section 128. In some implementations, the optical coupling may be an evanescent-wave coupling.

As indicated above, FIG. 3 is provided as an example. Other examples may differ from what is described with regard to FIG. 3.

The following provides an overview of some Aspects of the present disclosure:
Aspect 1: An interlayer transition coupling structure, comprising: a first lateral interface and a second lateral interface that are perpendicular to a first lateral axis and define a lengthwise dimension of the interlayer transition coupling structure; a first lateral side and a second lateral side that are perpendicular to a second lateral axis and define a widthwise dimension of the interlayer transition coupling structure; a cladding layer; a first waveguide layer arranged in the cladding layer and configured to guide a first optical signal lengthwise along at least a first portion of the interlayer transition coupling structure; and a second waveguide layer arranged in the cladding layer and configured to guide a second optical signal lengthwise along at least a second portion of the interlayer transition coupling structure, wherein the first waveguide layer and the second waveguide layer are spatially overlapped in a vertical direction in a third portion of the interlayer transition coupling structure, wherein the first waveguide layer and the second waveguide layer are optically coupled in the vertical direction to transfer an optical signal between the first waveguide layer and the second waveguide layer, wherein the first waveguide layer includes: a first constant width section that extends lengthwise, along a first center axis, from the first lateral interface toward the second lateral interface, wherein the first constant width section has a first constant width; a first tapered width section that extends lengthwise, along the first center axis, from the first constant width section toward the second lateral interface, wherein the first tapered width section has a first tapered width that tapers from the first constant width section to a first tip section having a first tip width; and a first displacing waveguide section that extends from the first tip section to the second lateral interface, wherein the first displacing waveguide section has a first displaced waveguide tip, arranged at the second lateral interface, that has a first lateral offset distance from the first center axis, wherein the second waveguide layer includes: a second constant width section that extends lengthwise, along a second center axis, from the second lateral interface toward the first lateral interface, wherein the second constant width section has a second constant width; and a second tapered width section that extends lengthwise, along the second center axis, from the second constant width section toward the first lateral interface, wherein the second tapered width section has a second tapered width that tapers from the second constant width section to a second tip section having a second tip width.
Aspect 2: The interlayer transition coupling structure of Aspect 1, wherein the first displacing waveguide section extends from the first tip section to the second lateral interface in both a first lateral direction that is parallel to the first lateral axis and a second lateral direction that is parallel to the second lateral axis.
Aspect 3: The interlayer transition coupling structure of any of Aspects 1-2, wherein the first displacing waveguide section is a straight waveguide that extends from the first tip section to the second lateral interface in both a first lateral direction that is parallel to the first lateral axis and a second lateral direction that is parallel to the second lateral axis.
Aspect 4: The interlayer transition coupling structure of any of Aspects 1-3, wherein the first displacing waveguide section is a curved waveguide having one or more curves, wherein the first displacing waveguide section extends in a first lateral direction that is parallel to the first lateral axis and in a second lateral direction that is parallel to the second lateral axis.
Aspect 5: The interlayer transition coupling structure of any of Aspects 1-4, wherein the first displacing waveguide section is a slanted waveguide that slants at an offset angle relative to the first center axis and extends from the first tip section at the offset angle toward the second lateral side.
Aspect 6: The interlayer transition coupling structure of Aspect 5, wherein the offset angle is in a range between 0.5° to 20°.
Aspect 7: The interlayer transition coupling structure of any of Aspects 1-6, wherein the first constant width section and the second tapered width section are spatially overlapped in the vertical direction.
Aspect 8: The interlayer transition coupling structure of any of Aspects 1-7, wherein the second constant width section and the first tapered width section are spatially overlapped in the vertical direction.
Aspect 9: The interlayer transition coupling structure of any of Aspects 1-8, wherein the first constant width section and the second tapered width section are spatially overlapped in the vertical direction, wherein the second constant width section and the first tapered width section are spatially overlapped in the vertical direction, and wherein a first lateral end portion of the first constant width section is spatially overlapped with a second lateral end portion of the second constant width section.
Aspect 10: The interlayer transition coupling structure of any of Aspects 1-9, wherein a coupling portion of the first displacing waveguide section is spatially overlapped with the second constant width section, wherein an area of overlap between the coupling portion and the second constant width section in the vertical direction gradually decreases as the first displacing waveguide section extends from the first tip section toward the second lateral interface, and wherein the coupling portion is optically coupled to the second constant width section.
Aspect 11: The interlayer transition coupling structure of Aspect 10, wherein the first displaced waveguide tip and the second waveguide layer are not spatially overlapped in the vertical direction.
Aspect 12: The interlayer transition coupling structure of any of Aspects 1-11, wherein the first displacing waveguide section extends from the first tip section to the second lateral interface such that a spatial overlap between the first displacing waveguide section and the second constant width section gradually decreases.
Aspect 13: The interlayer transition coupling structure of any of Aspects 1-12, wherein the first displacing waveguide section is configured to conduct the optical signal from a first region that is spatially overlapped with the second waveguide layer to a second region that is not spatially overlapped with the second waveguide layer.
Aspect 14: The interlayer transition coupling structure of any of Aspects 1-13, wherein the first lateral offset distance is sufficiently large such that one or more effective indices of one or more waveguide modes of the second waveguide layer have a negligible change as the one or more waveguide modes cross a boundary between the first tip section and the second lateral interface.
Aspect 15: The interlayer transition coupling structure of any of Aspects 1-14, wherein the first center axis and the second center axis are colinear.
Aspect 16: The interlayer transition coupling structure of Aspect 15, wherein the second tip section is spatially overlapped with the first constant width section.
Aspect 17: The interlayer transition coupling structure of any of Aspects 1-16, wherein the first center axis and the second center axis are laterally offset by a second lateral offset distance in a first lateral direction that is parallel to the second lateral axis.
Aspect 18: The interlayer transition coupling structure of Aspect 17, wherein the second tip section is not spatially overlapped with the first constant width section.
Aspect 19: The interlayer transition coupling structure of Aspect 17, wherein the first lateral offset distance extends from the first center axis in a second lateral direction that is parallel to the second lateral axis, and wherein the first lateral direction and the second lateral direction are opposite directions.
Aspect 20: The interlayer transition coupling structure of any of Aspects 1-19, wherein the first waveguide layer and the second waveguide layer are part of a same waveguide layer having different thicknesses.
Aspect 21: The interlayer transition coupling structure of Aspect 20, wherein the first optical signal and the second optical signal are a same optical signal.
Aspect 22: The interlayer transition coupling structure of any of Aspects 1-21, wherein the first waveguide layer and the second waveguide layer are spatially separated in the vertical direction by a portion of the cladding layer.
Aspect 23: The interlayer transition coupling structure of any of Aspects 1-22, wherein the first waveguide layer and the second waveguide layer are optically coupled in the vertical direction by an evanescent-wave coupling to transfer an optical power between the first waveguide layer and the second waveguide layer.
Aspect 24: The interlayer transition coupling structure of Aspect 23, wherein the first optical signal and the second optical signal are different optical signals having substantially equal effective propagation indices.
Aspect 25: The interlayer transition coupling structure of any of Aspects 1-24, wherein the first waveguide layer is made of a first waveguide material, and wherein the second waveguide layer is made of a second waveguide material that is different from the first waveguide material.
Aspect 26: The interlayer transition coupling structure of any of Aspects 1-25, wherein the first waveguide layer is a first waveguide core and the second waveguide layer is a second waveguide core.
Aspect 27: The interlayer transition coupling structure of any of Aspects 1-26, wherein the first displacing waveguide section is configured to reduce at least one of: a mode mismatch loss of the optical signal, which is transferred between the first waveguide layer and the second waveguide layer, a back reflection between the first waveguide layer and the second waveguide layer during transfer of the optical signal, or a crosstalk between the first waveguide layer and the second waveguide layer during transfer of the optical signal.
Aspect 28: The interlayer transition coupling structure of any of Aspects 1-27, wherein the second waveguide layer has a third tapered section that tapers lengthwise, along the second center axis, from the second constant width section away from the first lateral interface and away from the second lateral interface.
Aspect 29: A multicore waveguide, comprising: a first lateral interface and a second lateral interface that are perpendicular to a first lateral axis and define a lengthwise dimension of the multicore waveguide; a first lateral side and a second lateral side that are perpendicular to a second lateral axis and define a widthwise dimension of the multicore waveguide; a cladding layer; a first waveguide core arranged in the cladding layer and configured to guide a first optical signal lengthwise along at least a first portion of the multicore waveguide; and a second waveguide core arranged in the cladding layer and configured to guide a second optical signal lengthwise along at least a second portion of the multicore waveguide, wherein the first waveguide core and the second waveguide core are spatially overlapped in a vertical direction in a third portion of the multicore waveguide, wherein the first waveguide core and the second waveguide core are optically coupled in the vertical direction to transfer an optical signal between the first waveguide core and the second waveguide core, wherein the first waveguide core includes: a first constant width section that extends lengthwise, along a first center axis, from the first lateral interface toward the second lateral interface, wherein the first constant width section has a first constant width; a first tapered width section that extends lengthwise, along the first center axis, from the first constant width section toward the second lateral interface, wherein the first tapered width section has a first tapered width that tapers from the first constant width section to a first tip section having a first tip width; and a first displacing waveguide section that extends from the first tip section to the second lateral interface, wherein the first displacing waveguide section has a first displaced waveguide tip, arranged at the second lateral interface, that has a first lateral offset distance from the first center axis, wherein the second waveguide core includes: a second constant width section that extends lengthwise, along a second center axis, from the second lateral interface toward the first lateral interface, wherein the second constant width section has a second constant width; and a second tapered width section that extends lengthwise, along the second center axis, from the second constant width section toward the first lateral interface, wherein the second tapered width section has a second tapered width that tapers from the second constant width section to a second tip section having a second tip width.
Aspect 30: An interlayer transition coupling structure, comprising: a first waveguide mode path configured to propagate a first waveguide mode; and a second waveguide mode path configured to propagate a second waveguide mode, wherein the first waveguide mode path and the second waveguide mode path are partially overlapped and are configured to couple the first waveguide mode and second waveguide mode, wherein the first waveguide mode path has a waveguide tip section, wherein the first waveguide mode path has a displacement mode path starting at the waveguide tip section, wherein the displacement mode path is gradually displaced from the second waveguide mode path, and wherein the displacement mode path is configured to gradually decouple the first waveguide mode from the second waveguide mode or gradually couple the first waveguide mode to the second waveguide mode.
Aspect 31: A system configured to perform one or more operations recited in one or more of Aspects 1-30.
Aspect 32: An apparatus comprising means for performing one or more operations recited in one or more of Aspects 1-30.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An interlayer transition coupling structure, comprising:
a first lateral interface and a second lateral interface that are perpendicular to a first lateral axis and define a lengthwise dimension of the interlayer transition coupling structure;
a first lateral side and a second lateral side that are perpendicular to a second lateral axis and define a widthwise dimension of the interlayer transition coupling structure;
a cladding layer;
a first waveguide layer arranged in the cladding layer and configured to guide a first optical signal lengthwise along at least a first portion of the interlayer transition coupling structure; and
a second waveguide layer arranged in the cladding layer and configured to guide a second optical signal lengthwise along at least a second portion of the interlayer transition coupling structure,
wherein the first waveguide layer and the second waveguide layer are spatially overlapped in a vertical direction in a third portion of the interlayer transition coupling structure,
wherein the first waveguide layer and the second waveguide layer are optically coupled in the vertical direction to transfer an optical signal between the first waveguide layer and the second waveguide layer,
wherein the first waveguide layer includes:
a first constant width section that extends lengthwise, along a first center axis, from the first lateral interface toward the second lateral interface, wherein the first constant width section has a first constant width;
a first tapered width section that extends lengthwise, along the first center axis, from the first constant width section toward the second lateral interface, wherein the first tapered width section has a first tapered width that tapers from the first constant width section to a first tip section having a first tip width; and
a first displacing waveguide section that extends from the first tip section to the second lateral interface, wherein the first displacing waveguide section has a first displaced waveguide tip, arranged at the second lateral interface, that has a first lateral offset distance from the first center axis,
wherein the second waveguide layer includes:
a second constant width section that extends lengthwise, along a second center axis, from the second lateral interface toward the first lateral interface, wherein the second constant width section has a second constant width; and
a second tapered width section that extends lengthwise, along the second center axis, from the second constant width section toward the first lateral interface, wherein the second tapered width section has a second tapered width that tapers from the second constant width section to a second tip section having a second tip width.

2. The interlayer transition coupling structure of claim 1, wherein the first displacing waveguide section extends from the first tip section to the second lateral interface in both a first lateral direction that is parallel to the first lateral axis and a second lateral direction that is parallel to the second lateral axis.

3. The interlayer transition coupling structure of claim 1, wherein the first displacing waveguide section is a straight waveguide that extends from the first tip section to the second lateral interface in both a first lateral direction that is parallel to the first lateral axis and a second lateral direction that is parallel to the second lateral axis.

4. The interlayer transition coupling structure of claim 1, wherein the first displacing waveguide section is a curved waveguide having one or more curves, wherein the first displacing waveguide section extends in a first lateral direction that is parallel to the first lateral axis and in a second lateral direction that is parallel to the second lateral axis.

5. The interlayer transition coupling structure of claim 1, wherein the first displacing waveguide section is a slanted waveguide that slants at an offset angle relative to the first center axis and extends from the first tip section at the offset angle toward the second lateral side.

6. The interlayer transition coupling structure of claim 5, wherein the offset angle is in a range between 0.5° to 20°.

7. The interlayer transition coupling structure of claim 1, wherein the first constant width section and the second tapered width section are spatially overlapped in the vertical direction.

8. The interlayer transition coupling structure of claim 1, wherein the second constant width section and the first tapered width section are spatially overlapped in the vertical direction.

9. The interlayer transition coupling structure of claim 1, wherein the first constant width section and the second tapered width section are spatially overlapped in the vertical direction,
wherein the second constant width section and the first tapered width section are spatially overlapped in the vertical direction, and
wherein a first lateral end portion of the first constant width section is spatially overlapped with a second lateral end portion of the second constant width section.

10. The interlayer transition coupling structure of claim 1, wherein a coupling portion of the first displacing waveguide section is spatially overlapped with the second constant width section,
wherein an area of overlap between the coupling portion and the second constant width section in the vertical direction gradually decreases as the first displacing waveguide section extends from the first tip section toward the second lateral interface, and
wherein the coupling portion is optically coupled to the second constant width section.

11. The interlayer transition coupling structure of claim 10, wherein the first displaced waveguide tip and the second waveguide layer are not spatially overlapped in the vertical direction.

12. The interlayer transition coupling structure of claim 1, wherein the first displacing waveguide section extends from the first tip section to the second lateral interface such that a spatial overlap between the first displacing waveguide section and the second constant width section gradually decreases.

13. The interlayer transition coupling structure of claim 1, wherein the first displacing waveguide section is configured to conduct the optical signal from a first region that is spatially overlapped with the second waveguide layer to a second region that is not spatially overlapped with the second waveguide layer.

14. The interlayer transition coupling structure of claim 1, wherein the first lateral offset distance is sufficiently large such that one or more effective indices of one or more waveguide modes of the second waveguide layer have a negligible change as the one or more waveguide modes cross a boundary between the first tip section and the second lateral interface.

15. The interlayer transition coupling structure of claim 1, wherein the first center axis and the second center axis are colinear.

16. The interlayer transition coupling structure of claim 15, wherein the second tip section is spatially overlapped with the first constant width section.

17. The interlayer transition coupling structure of claim 1, wherein the first center axis and the second center axis are laterally offset by a second lateral offset distance in a first lateral direction that is parallel to the second lateral axis.

18. The interlayer transition coupling structure of claim 17, wherein the second tip section is not spatially overlapped with the first constant width section.

19. The interlayer transition coupling structure of claim 17, wherein the first lateral offset distance extends from the first center axis in a second lateral direction that is parallel to the second lateral axis, and
wherein the first lateral direction and the second lateral direction are opposite directions.

20. The interlayer transition coupling structure of claim 1, wherein the first waveguide layer and the second waveguide layer are part of a same waveguide layer having different thicknesses.

21. The interlayer transition coupling structure of claim 20, wherein the first optical signal and the second optical signal are a same optical signal.

22. The interlayer transition coupling structure of claim 1, wherein the first waveguide layer and the second waveguide layer are spatially separated in the vertical direction by a portion of the cladding layer.

23. The interlayer transition coupling structure of claim 1, wherein the first waveguide layer and the second waveguide layer are optically coupled in the vertical direction by an evanescent-wave coupling to transfer an optical power between the first waveguide layer and the second waveguide layer.

24. The interlayer transition coupling structure of claim 23, wherein the first optical signal and the second optical signal are different optical signals having substantially equal effective propagation indices.

25. The interlayer transition coupling structure of claim 1, wherein the first waveguide layer is made of a first waveguide material, and
wherein the second waveguide layer is made of a second waveguide material that is different from the first waveguide material.

26. The interlayer transition coupling structure of claim 1, wherein the first waveguide layer is a first waveguide core and the second waveguide layer is a second waveguide core.

27. The interlayer transition coupling structure of claim 1, wherein the first displacing waveguide section is configured to reduce at least one of:
a mode mismatch loss of the optical signal, which is transferred between the first waveguide layer and the second waveguide layer,
a back reflection between the first waveguide layer and the second waveguide layer during transfer of the optical signal, or
a crosstalk between the first waveguide layer and the second waveguide layer during transfer of the optical signal.

28. The interlayer transition coupling structure of claim 1, wherein the second waveguide layer has a third tapered section that tapers lengthwise, along the second center axis, from the second constant width section away from the first lateral interface and away from the second lateral interface.

29. A multicore waveguide, comprising:
a first lateral interface and a second lateral interface that are perpendicular to a first lateral axis and define a lengthwise dimension of the multicore waveguide;
a first lateral side and a second lateral side that are perpendicular to a second lateral axis and define a widthwise dimension of the multicore waveguide;
a cladding layer;
a first waveguide core arranged in the cladding layer and configured to guide a first optical signal lengthwise along at least a first portion of the multicore waveguide; and
a second waveguide core arranged in the cladding layer and configured to guide a second optical signal lengthwise along at least a second portion of the multicore waveguide,
wherein the first waveguide core and the second waveguide core are spatially overlapped in a vertical direction in a third portion of the multicore waveguide,
wherein the first waveguide core and the second waveguide core are optically coupled in the vertical direction to transfer an optical signal between the first waveguide core and the second waveguide core,
wherein the first waveguide core includes:
a first constant width section that extends lengthwise, along a first center axis, from the first lateral interface toward the second lateral interface, wherein the first constant width section has a first constant width;
a first tapered width section that extends lengthwise, along the first center axis, from the first constant width section toward the second lateral interface, wherein the first tapered width section has a first tapered width that tapers from the first constant width section to a first tip section having a first tip width; and
a first displacing waveguide section that extends from the first tip section to the second lateral interface, wherein the first displacing waveguide section has a first displaced waveguide tip, arranged at the second lateral interface, that has a first lateral offset distance from the first center axis,
wherein the second waveguide core includes:
a second constant width section that extends lengthwise, along a second center axis, from the second lateral interface toward the first lateral interface, wherein the second constant width section has a second constant width; and
a second tapered width section that extends lengthwise, along the second center axis, from the second constant width section toward the first lateral interface, wherein the second tapered width section has a second tapered width that tapers from the second constant width section to a second tip section having a second tip width.

30. An interlayer transition coupling structure, comprising:
a first waveguide mode path configured to propagate a first waveguide mode; and
a second waveguide mode path configured to propagate a second waveguide mode,
wherein the first waveguide mode path and the second waveguide mode path are partially overlapped and are configured to couple the first waveguide mode and second waveguide mode,
wherein the first waveguide mode path has a waveguide tip section,
wherein the first waveguide mode path has a displacement mode path starting at the waveguide tip section, wherein the displacement mode path is gradually displaced from the second waveguide mode path, and
wherein the displacement mode path is configured to gradually decouple the first waveguide mode from the second waveguide mode or gradually couple the first waveguide mode to the second waveguide mode.
